(19) United States
(12) Patent Application Publication
(10) Pub. No.: US 2008/0294446 A1
(43) Pub. Date: Nov. 27, 2008

(54) Layer based scalable multimedia datastream compression

(76) Inventors: Linfeng Guo, Cliffside Park, NJ (US); Hua Zheng, Secaucus, NJ (US); Mark Sydorenko, New York, NY (US); Yang Li, South Plainfield, NJ (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/805,245

(22) Filed: May 22, 2007

(51) Int. Cl. G10L 19/00

(52) U.S. Cl. 704/501; 704/E19.001

(57) ABSTRACT

Source signals, such as audio and/or video data, are encoded into multiple, consecutive frequency bands. These bands are referred to as coding layers. Rather than performing complex bit-slice operations, a disclosed technique enables an agile and simplified response to transmission channel throughput variations. Specifically, if it becomes necessary to restrict the rate of data transmission to avoid receiver buffer underflow resulting from transmission channel degradation, layers from the transmitted signal are omitted, beginning with the highest frequency bands. Efficient and agile bit rate scalability during data streaming through wired or wireless networks and during local playback is thus enabled.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

In general, the perceptual quality of a compressed audio signal is determined by the encoding bit rate employed. The higher the bit rate, the better the perceptual quality of the compressed audio data. Audio signal compression is typically performed through one of two methods: by removing the redundancy inherent in the audio signal through entropy encoding or by not preserving information in the audio signal that cannot be perceived by the human auditory system. When a compressed audio signal is to be streamed in real-time through a dedicated network connection having a fixed throughput capacity (e.g., a T1 line), the highest possible bit rate can be used to achieve the optimal compressed audio file.

However, when an audio signal compressed at a single bit rate is to be streamed through an unstable connection such as in a wireless network, which can be prone to frequent and unpredictable maximum bandwidth fluctuation, playback interruption may be experienced when the connection bandwidth drops below the transmission rate and receiver buffer underflow results. Playback interruption can be mitigated in such a scenario by reducing the audio bit rate. The prior art includes techniques whereby the original audio signal is compressed in advance to several different encoding bit rates (e.g., 64 Kbps, 48 Kbps, 32 Kbps, and 16 Kbps) thereby enabling the client-server to choose the appropriate compressed file (bit rate) for streaming based upon the detected conditions of the target connection. However, it is inefficient to compress a single source file at each of plural bit rates in terms of the resources necessary to code the files and the memory required to store them. In addition, the difference between a representation of a source signal encoded at one bit rate and a representation encoded at the next lower bit rate may be excessive in terms of the realized bandwidth reduction. To achieve optimal results, it would be necessary to provide as many compressed data files of each source signal as possible to avoid overcompensation in terms of streaming bit-rate reduction when experiencing connection degradation.

The problem thus becomes how to optimally encode the source signal such that bit rate scaling can be performed during streaming in response to connection conditions without the need for multiple versions of the same source signal, each encoded at a respective bit rate.

There are several techniques known in the art for performing transmission bit rate scaling that do not entail encoding the source into multiple files of different bit rates. These are generally referred to as layer-based scalable coding techniques. The minimum subset that can be decoded for useful audio is the base layer. One or more enhancement layers are provided, depending upon connection characteristics. A layer-based technique enables the removal of a portion of the encoded file according to the condition of the connection through which the file is to be streamed.

One known technique is referred to as Advanced Audio Coding (AAC) multi-compression-based scalable coding, or the AAC Large Step Scalable System. Each coding frame is divided into plural subbands, each subband corresponding to a respective frequency range.

In general, and as illustrated in FIG. 1, such a system involves cascaded coder/decoder pairs. The input signal 10 is coded then provided to a multiplexer for bitstream 19 assembly. This first bitstream is regarded as the base layer 12. The coded signal is also decoded and used in the generation of an error signal as the difference between the encoded/decoded signal and the original signal 10. This error signal is then processed by a second coder/decoder pair as above. The resulting bitstream 14 is regarded as the first enhancement layer. Additional enhancement layers 16, 18 are also provided. The base layer and optionally one or more enhancement layers are then multiplexed to form the bitstream 19 for transmission. While the base layer provides the most relevant components of the signal at a basic quality level, the enhancement layers enhance the coding precision delivered.

FIG. 2 illustrates an MPEG-4 scalable audio coder based on a so-called “core encoder,” or a base layer coder operating at a lower sampling frequency than that of the source. The input signal 30 is down-sampled (as represented by the “down” arrow) and encoded by the core encoder. The resulting core layer bitstream 32 is both forwarded to a bitstream multiplexer as well as to a core decoder. The decoded output signal is up-sampled to the rate of the enhancement layer encoder (as represented by the “up” arrow) and passed through a Modified Discrete Cosine Transform (MDCT) analysis filter bank. In a parallel signal path, the delay-compensated original input signal 30 is passed through the MDCT analysis filter bank. A so-called Frequency Selective Switch (FSS) permits the choice of coding the spectral coefficients of the input signal versus coding the spectral coefficients of the difference or residual signal on a scale factor band basis. The assembled spectrum from the FSS is then quantized and coded by the AAC coding kernel. The output 34 represents an enhancement layer bitstream which is multiplexed into the composite output bitstream.

Another technique called Bit-Sliced Arithmetic Coding (BSAC), a tool defined for the MPEG-4 audio coding toolset, provides scalability at steps down to 1 kbit/s per channel. Bitstream scalability represents the ability of an audio codec to support an ordered set of bit-streams which can produce a reconstructed sequence. The codec can output useful audio when certain subsets of the bit stream are decoded. To obtain such fine grain scalability, a bit-slice scheme is applied to the quantized spectral data.

The following is an example of how a bit-slice technique is applied to the quantized spectral data provided by the multiplexer. With respect to FIG. 3, the quantized spectral values are grouped into (vertical) frequency bands, each group containing the quantized spectral coefficients in a binary representation. Instead of coding the signal in the coefficient-by-coefficient manner, the same bit across several or all coefficients of like significance and similar spectral content are grouped together as a bitplane and coded as a single unit. In FIG. 3, the top row and bottom rows are labeled “BITPLANE 0” and “BITPLANE 6”, respectively. Further, coefficients from plural bitplanes can be grouped together to form units referred to as bitplane slices. The use of five bitplane slices for encoding the four subbands is illustrated in FIG. 3. The most significant bits (MSBs) of the quantized values in the group are processed and the bits are processed from lower to higher frequencies within a given slice. In this context, “processing” involves encoding using a binary arithmetic coding technique to obtain entropy coding with minimal redundancy. With more enhancement layers utilized by the decoder, more least significant bit (LSB) information refines the quantized spectral data. At the same time, providing bit-slices of spectral data in higher frequency bands increases the audio bandwidth.

When these slices are multiplexed into a single bitstream in the proper order, the streaming server will be able to truncate the bitstream at the points between any two adjacent bitplane slices and dynamically re-generate a bitstream at a lower bit rate. The biggest advantage of this technique is the flexibility of bit rate control during encoding and transmission. The disadvantage of the technique is that it is very difficult to achieve the optimal rate-distortion result at most truncation points, and its complexity level can be very high. A simpler technique for enabling dynamic, fine-granularity scalability of streaming data is thus required.

### BRIEF SUMMARY OF THE INVENTION

The presently disclosed method and apparatus are based upon the Neural Encoding Model (NEM) described in U.S. Pat. No. 6,091,773 (Sydorenko), incorporated herein by reference. The NEM encodes source signals into multiple, consecutive frequency bands. These bands are referred to as coding layers. Rather than performing complex bit-slice operations as required by the prior art, the presently disclosed invention takes advantage of the frequency-specific representation of the encoded source signal in providing an agile and simplified response to transmission channel throughput variations. Specifically, if it becomes necessary to restrict the rate of data transmission in order to avoid receiver buffer underflow resulting from transmission channel degradation, the presently disclosed technique omits layers from the transmitted signal, beginning with the highest frequency bands. Extremely efficient and agile bit rate scalability during data streaming through wired or wireless networks and during local playback is thus enabled.

### BRIEF DESCRIPTION OF THE SEVERAL VIEWS OF THE DRAWINGS

The invention will be more fully understood by reference to the following description in conjunction with the accompanying drawings, of which:

FIG. 1 is a block diagram of a prior art multi-compression-based scalable coding system;

FIG. 2 is a block diagram of a prior art MPEG-4 scalable audio coder;

FIG. 3 illustrates bitstream coefficient organization according to a prior art bit-sliced arithmetic coding system;

FIG. 4 is a block diagram of a system for encoding, storing, and streaming multimedia content according to the presently disclosed invention;

FIG. 5 is a block diagram of a coder employed in the presently disclosed invention;

FIG. 6 is a block diagram of a Neural Encoding Model (NEM) Processor as employed in the presently disclosed invention;

FIG. 7 is a block diagram of a Perceptual Distance Processor as employed in the presently disclosed invention;

FIG. 8 illustrates the format of a streaming data packet header according to the presently disclosed invention;

FIG. 9 illustrates a scalable encoded frame, formed of three frequency-specific layers, according to the presently disclosed invention;

FIG. 10 is a diagram of functional blocks utilized in implementing scalable dynamic streaming according to the presently disclosed invention; and

FIG. 11 is a diagram of tasks used to implement scalable dynamic streaming according to the presently disclosed invention.

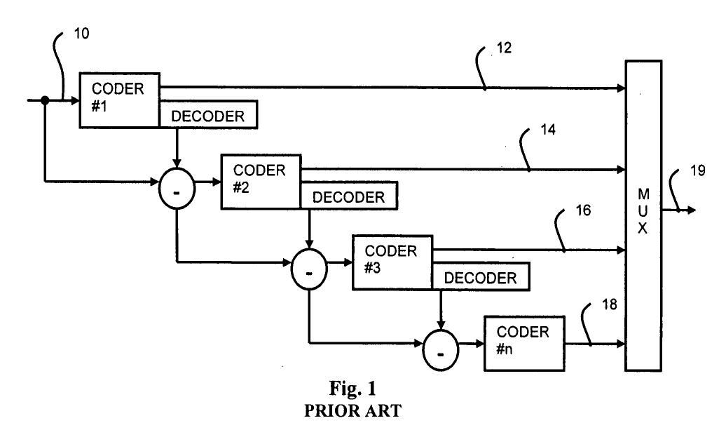

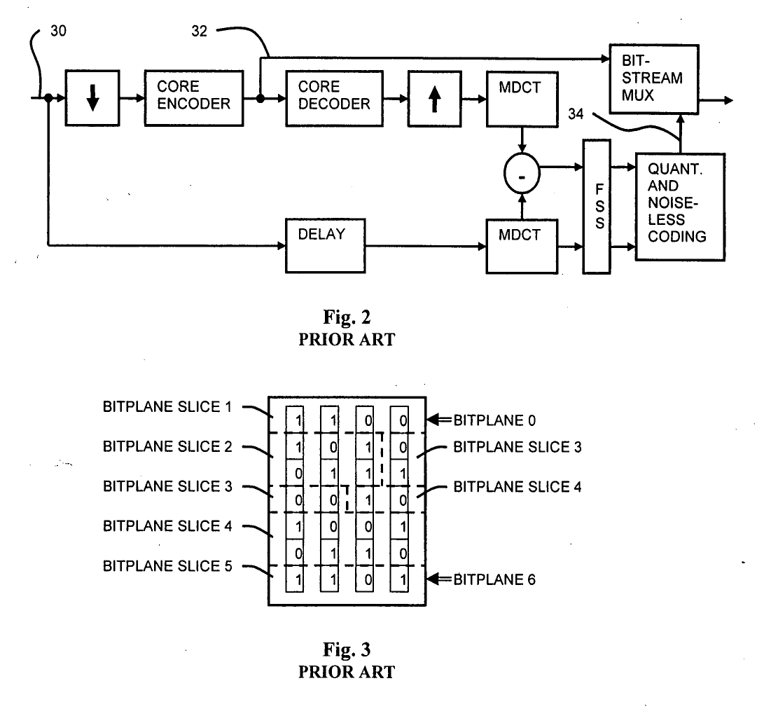

### DETAILED DESCRIPTION OF THE INVENTION

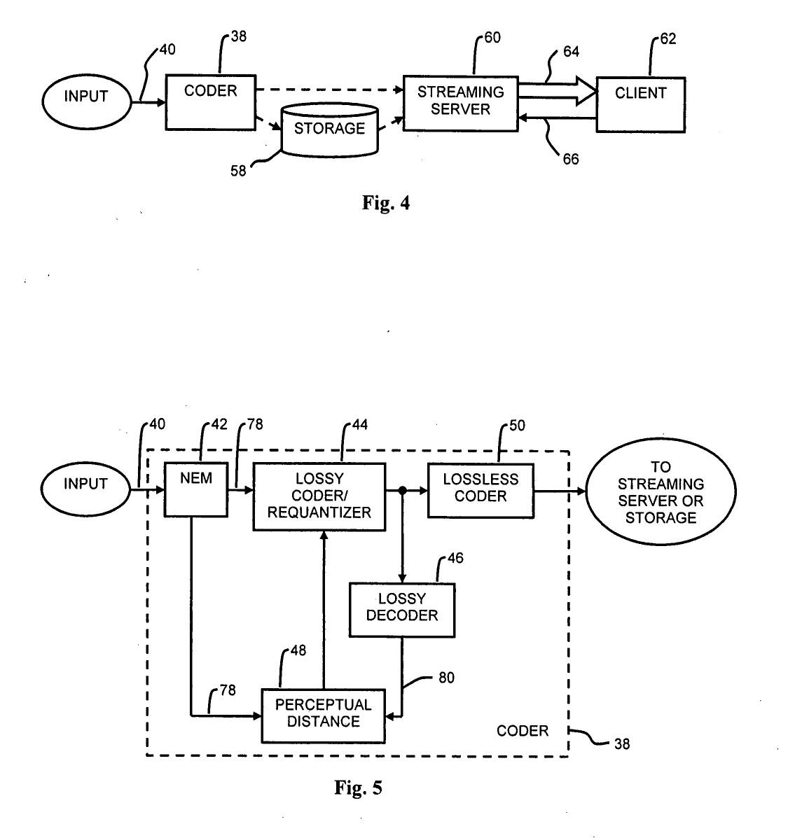

The presently disclosed invention pertains to a technique for intelligently scaling a compressed source signal in a streaming data server in response to fluctuations in the throughput capacity of a wired or wireless data communications channel. The overall context of this disclosure is shown in FIG. 4, in which a source signal 40, such as an audio or video data file, is input to a coder 38. The encoded source file is then provided directly to a streaming server 60 or to storage 58 for retrieval by the streaming server as required. Depending upon the throughput capacity of the communications channel 64 between the streaming server and a receiving client 62, as derived from feedback 66 provided by the client, the server may enforce bit rate scalability in order to avoid client buffer underflow resulting from communications channel data throughput degradation.

The functions provided by the blocks of FIG. 4 may be implemented through the use of either shared or dedicated hardware, including, but not limited to, hardware (e.g., state machines) capable of executing software. However, the use of the term “processor” herein should not be construed to refer exclusively to hardware capable of executing software. Illustrative embodiments comprise, singularly or in combination, digital signal processor (DSP) hardware, or personal computer (PC) hardware, and software performing the operations discussed below. Very large scale integration (VLSI) hardware embodiments of the present invention, as well as hybrid DSP/VLSI embodiments, may also be employed in realizing the presently disclosed system.

The client may be embodied by one of many devices utilized for rendering audio and/or video data received via wired or wireless connections. Examples include networked MP3 players, personal computers, and telephones. However, the presently disclosed technique for adaptive scaling is particularly suited to wireless connections due to their inherently dynamic throughput characteristics. These specific implementations are exemplary, and do not represent an exhaustive list of all suitable alternatives.

U.S. Pat. No. 6,091,773 (Sydorenko) describes a method for measuring the perceptual distance between an original version of a sensory signal, such as an audio or video signal, and an approximate, reconstructed representation of the original sensory signal. The perceptual distance in this context is a direct quantitative measure of the likelihood that a human observer can distinguish the original audio or video signal from the reconstructed approximation to the original audio or video signal. The method is based on a theory of the neurophysiological limitations of human sensory perception. Specifically, the Neural Encoding Model (NEM) summarizes the manner in which sensory signals are represented in the human brain. NEM is analyzed in the context of detection theory which provides a mathematical framework for statistically quantifying the detectability of differences in the neural representation arising from differences in sensory input. The described method does not involve either source model techniques or receiver model techniques based upon psychoacoustic or “masking” phenomena. Rather, the described method and apparatus provide a neurophysiologically-based receiver model that includes uniquely derived extensions from detection theory to quantify the perceptibility of perturbations (noise) in the approximately reconstructed signal.

As discussed below, NEM is employed to illustrate the presently disclosed technique for enabling dynamic scaling of multimedia datastreams. However, the presently disclosed technique can be generalized to any coder that encodes source signals into multiple, independently decodable, consecutive frequency bands.

In one embodiment of a coder 38 described in Sydorenko and with reference to FIG. 5, an original source signal 40, such as an audio file, is input to and processed by an NEM module 42, described in further detail below. Essentially, the NEM module separates the datastream into adjacent frequency bands or “layers.” The layered output 78 of the NEM module is then processed by a lossy coder 44, which is alternatively referred to as a requantizer. The lossy coder intelligently reduces the number of bits required to represent the NEM processed input audio signal. The output of the lossy coder is then processed by a lossless coder 50 prior to transmission to a client device or to storage. In the case of a transmitted signal, a receiver (not illustrated) subjects the transmitted and received signal to a lossless decoder, which is the inverse of the lossless coder 50, followed by a lossy decoder, which is essentially the inverse of the lossy coder 44.

In order to gauge the impact of the lossy coder 44 on the source signal 40, the output of the lossy coder is also processed by a lossy decoder 46. Ignoring any transmission channel effects, the lossy decoder 46 in the base coder 38 provides a signal 80 which is essentially identical to what would be recovered in a receiving device. The output of the lossy decoder 80 is then compared to the NEM processed source signal 78 by an NEM perceptual distance analyzer 48 which computes the likelihood that a human could discriminate between the two representations.

The output of the NEM perceptual distance module 48 is used by a bit allocation algorithm in the lossy coder/requantizer 44, where an attempt is made to optimize the allocation of bits needed to encode the source signal. The NEM representation 78 is requantized, with bit allocation controlled by the perceptual distance calculation 48, such that the perceptual distance, in each band, is held below a specified perceptual distance threshold. Thus, the requantizer and the perceptual distance calculation form a computational loop that searches for the optimal bit allocation. One of two optimal modes, variable bit-rate mode or constant bit-rate mode, may be enforced by the bit allocation algorithm. In the former, the bit allocation algorithm employs enough bits to achieve a desired perceptual distance threshold without using excess bits that would not contribute to the perceived quality of the received signal. In the latter, the algorithm attempts to distribute bits consistent with the bit budget (i.e. maximum bit rate) while still achieving an acceptable or minimal perceptual distance. The bit rate after the lossless coder 50 is monitored (not illustrated) to ensure compliance with the bit budget.

The lossy coder/requantizer module 44 uses a reduced number of bits to represent an approximation to the input 78 from the NEM module 42. A variety of vector quantization techniques can be used to implement the requantization. One straight-forward approach includes, for each channel or groups of channels, computing a group scale factor (otherwise referred to as step size) and choosing a reduced number of quantization levels to approximate each NEM coefficient 78.

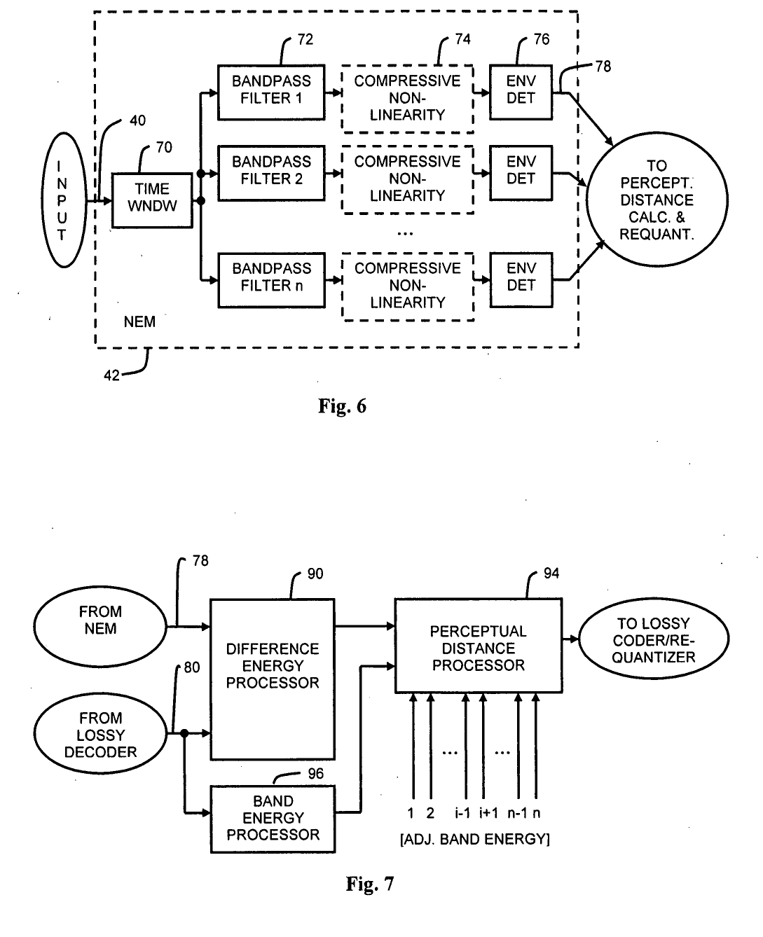

The NEM module 42 of FIG. 5 is illustrated in greater detail in FIG. 6. The NEM module includes a data windowing element (“TIME WNDW”) 70 followed by a bank of bandpass filters 72, an optional compressive non-linearity 74, and an envelope detector (“ENV DET”) 76. At this level, the system embodied in FIG. 6 represents a gross summary of the key physiological elements known to be involved in processing auditory information in humans. However, it will become apparent to those skilled in the field of auditory physiology and audio coding, that the specific best mode modifications (discussed below) to this basic structure are not consistent with published literature in the field of auditory physiology nor with the prior art in the fields of audio signal processing.

The data windowing processor 70 performs the operation of windowing successive blocks of the source datastream 40. The successive blocks of data may overlap in time, and the data blocks optionally may be re-sampled, in conjunction with the following Bandpass Filter processor 72, according to recently published critical sampling techniques that advantageously remove data redundancy while ensuring perfect-reconstruction (discussed below).

In one embodiment of the presently disclosed invention, the data window duration is in the range of 100 to 400 milliseconds. This choice of window duration is directly related to the perceptual distance calculation of the NEM perceptual distance analyzer 48, which in turn is directly based on a “neurophysiological buffer length.” The neurophysiological buffer length associated with the perceptual distance calculation describes the maximum duration of a sensory signal that the brain can analyze at one time. Those skilled in the field of detection theory will recognize that the choice of window (neurophysiological buffer) length has a critical bearing on the predictive accuracy of the perceptual distance calculation. Those skilled in the field of psychoacoustics will recognize that the neurophysiological buffer length, as it relates to human amplitude modulation detection thresholds, is approximately 300 milliseconds. Those skilled in the field of audio coding will recognize that a 100 to 400 millisecond window length is substantially longer than current practice, and substantially greater than that found in the prior art.

In one variation of the embodiment illustrated in FIG. 6 and alluded to previously, the data windowing function 70 can advantageously divide the window into two or more sub-windows of equal, shorter duration. Those skilled in the field of audio coding will recognize that shorter windows possess advantageous properties with respect to pre-echo control and I/O delay (for real-time applications). The shorter duration sub-windows permit the system to benefit from the properties of short windows while retaining the desirable best mode window duration for the perceptual distance calculation processor 48. For example, the windowing processor 70 may window successive (overlapping) 50 millisecond windows and pass them to the following bandpass filter processor 72. The envelope detector processor 76 may maintain a 200 millisecond FIFO buffer. As successive 50 millisecond data sub-windows replace the oldest 50 millisecond data sub-window in the 200 millisecond buffer, the lossy coder 44 bit allocation method loop processes the most current 50 millisecond sub-window in the context of all the data in the 200 millisecond buffer window. The former illustration is a specific example of plural embodiments that encompass any combination of window and sub-window duration provided the perceptual distance calculation 48 window is approximately 100 to 400 milliseconds in duration.

The bandpass filter bank 72 in FIG. 6 decomposes the windowed signal into multiple channels, each channel output being a time-domain representation of the windowed data in consecutive frequency bands, such that the sum over all channels perfectly reconstructs the input data 40. Various techniques may be used to implement the filter bank 72; no particular technique is critical to the practice of the present invention. Examples of possible filtering techniques include so-called Finite Impulse Response (FIR) filters and Infinite Impulse Response (IIR) filters, and implementations using techniques such as polynomial filters, or transforms such as the Discrete or Fast Fourier Transform (DFT or FFT), the Discrete Cosine Transform (DCT), the Quadrature Mirror Filter (QMF), and Time Domain Alias Cancellation (TDAC). This list is merely exemplary of suitable techniques and is not intended to be exhaustive.

Best mode dictates that the bandpass filters 72 all have bandwidths in the approximate range of 100 to 400 Hertz. As with the time window 70 duration, the choice of filter width is directly related to the perceptual distance calculation 48, which in turn is directly related to the “neurophysiological channel bandwidth capacity.” The neurophysiological channel bandwidth capacity describes the maximum amplitude modulation bandwidth encodable by a single neurophysiological channel. The perceptual distance calculation performed by the perceptual distance analyzer 48 computes the perceptual distance (discriminability) for each channel independently (discussed below). Hence, those skilled in the field of detection theory will recognize that the choice of filter bandwidth has a critical bearing on the predictive accuracy of the perceptual distance calculation. Those skilled in the field of psychoacoustics and auditory neurophysiology will recognize that these filter widths are substantially narrower and do not vary with center frequency as reported for auditory channels (known as “critical bands”). Those skilled in the field of audio coding will also recognize that 100 to 400 Hertz sub-band widths are substantially narrower than current practice, and substantially narrower than that found in the prior art.

The final two sub-processors in the NEM embodiment of FIG. 6, the compressive non-linearity 74 and the envelope detector 76, are conditionally optional. Conceptually, the envelope detector is critical to the implementation of the present invention. However, as it will become clear in the following discussion, variations of the illustrated general embodiment preserve the functional significance of the envelope detector 76 without explicitly including such sub-processors in the NEM module 42.

The exact form of the compressive non-linearity 74 has a minor bearing on the performance of the overall coder 38 in practice. Therefore, the compressive non-linearity 74 may be eliminated in variations of the illustrated embodiment for efficiency. A preferred embodiment requires the non-linearity to take the form of a mildly compressive instantaneous non-linearity. Good candidates resemble a logarithmic function or an exponential (in analogy with mu-law compression) of the form

output=|input|^{α}×sign(input),

where ⅓≦α≦1, |x|=absolute value of x,

$$and sign ( x ) = \{ \begin{matrix}1 & if x > 0 \\ 0 & if x = 0 \\ - 1 & if x < 0\end{matrix} \} .$$

Physiologically, the compressive non-linearity 74 represents the sum of the compressive contributions of the human cochlea and neurophysiological processing.

The envelope detector 76 (or demodulator) processor removes the carrier signal from the input and passes the modulator signal (the Hilbert envelope) as its output 78. The output of the envelope detector 76 is a critically sampled representation of the Hilbert envelope derived from the input to the envelope detector. Critical re-sampling of the detector 76 output signal reduces the overall sample rate (summed across all bands) down to the level of the input source sample rate. Various fundamental techniques well known to those skilled in the field of digital signal processing may be used to implement the envelope detector processor 76; the choice of technique is not critical to the practice of the present invention.

In a variation to the embodiment illustrated in FIG. 6, the compressive non-linearity processor 74 is placed after (rather than before) the envelope detector processor 76. This configuration has advantages, depending on the specific implementation of the present invention, such as lowering the computational load to the non-linearity processor due to the reduction of bit rate after the envelope detector, and offering computational efficiencies in specific frequency domain implementations of the NEM processor 42.

The output 78 of the NEM in FIG. 6, when incorporated into the coder system embodiment of FIG. 5, serves as the input into the perceptual distance calculation process 48 of coder 38 as well as the lossy coder/requantizer 44. The output 78 of the NEM processor of FIG. 6 contains a perfect-reconstruction representation of the windowed input source signal 40. This NEM representation 78 is re-quantized by the lossy coder/requantizer 44, under the control of the perceptual distance calculation 48, to become the input to the lossless coder 50 which further reduces the number of bits and generates a low bit rate representation by removing embedded data redundancy while preserving all information content. Such lossless techniques are collectively referred to as entropy encoding by those skilled in the art.

FIG. 7 illustrates an implementation of the perceptual distance calculation. The perceptual distance calculation is based on the following equations:

$$Preceptual Distance ( band i ) = \frac{DifferenceEnergy ( i )}{NoiseEnergy ( i )} .$$

where

$$Difference Energy ( i ) = {\sum }_{j = 1}^{\# coef i n band i} {( {x}_{j}^{i} - {y}_{j}^{i} )}^{2} ,$$

Noise Energy (i)=f(Band Energy (i)+Adjacent Band Energy (i))

$$Band Energy ( i ) = {\sum }_{j = 1}^{\# coef i n band i} {x}_{j}^{{i}^{2}} , \\ Adjacent Band Energy ( i ) = {\sum }_{k \neq i}^{all bands} ( β ( k , i ) {\sum }_{j = 1}^{\# coef i n band i} {x}_{j}^{{k}^{2}} ) ,$$

xⱼⁱ=j^{th} envelope coefficient of the i^{th} NEM band (output of NEM),

yⱼⁱ=j^{th} envelope coefficient of the i^{th} requantizer band (output of requantizer), and

0≦β(k,i)≦1.

For any given band i 78 out of the NEM module 42, the perceptual distance, when properly scaled, is a measure of the likelihood (as a probability ratio) that a human will be able to distinguish between the original source signal and the decoded, requantized, lossy signal in a standard psychoacoustic discrimination paradigm (e.g. a two-interval forced choice (2IFC) task). As it relates to the presently disclosed invention, the perceptual distance represents a metric whose value increases as the perceptibility of the difference between the source and lossy coded signal increases. The general idea is to keep the perceptual distance small, thereby lowering the probability that distortions due to lossy coding are detectable by a human observer.

As is apparent, the numerator of the perceptual distance equation is provided by the difference energy processor 90 and represents the difference in total energy, for the respective band, between the NEM processed source signal 78 and the requantized and lossy decoded version of the same 80.

The denominator of the perceptual distance equation, the noise energy (see equations above), represents a level of neural representational variability, or variance. In general, neural variance increases semi-proportionately with increasing signal level—semi-proportionately because the neural variance increases at a slightly lower rate than the signal level. The latter phenomenon is incorporated into the perceptual distance processor 94 by applying a mildly compressive function, f(x), in the noise energy equation (see above). This compressive function, f(x) in the noise energy equation shown above, can take a variety of forms depending upon the embodiment, including:

$$f ( x ) = x ( 1 - \frac{x}{α} ) ,$$

where α>2× (maximum absolute value of x), or f(x)=x^{α}, where 0.7≦α≦1.

Any compressive function with behavior similar to the functions above can be used to implement the present invention. In one embodiment of the presently disclosed invention, the choice of function f(x) includes letting f(x)=x, the omission of the compressive function altogether.

In an alternative embodiment, the function is replaced with the use of a series of look-up table values based upon empirical measures of just-noticeable differences in intensity for tones as a function of frequency and intensity.

The adjacent band energy equation, which is incorporated in the perceptual distance processor 94, represents noise (variance) contributed by neighboring bands via physiological mechanisms such as the spread of energy (excitation) within the cochlea, and convergent neural processing. Relative to the band energy measured by a band energy processor 96, the adjacent band energy 98 contributes a fractional amount to the total in the noise energy equation (see above). Energy contributed by adjacent bands decreases with increasing distance from the center band in a manner consistent with psychoacoustic measurements of the spread of masking in humans. Therefore, the values of the weighting factors, β, in the adjacent band energy equation shown above can be obtained directly from a variety of published measurements quantifying the spread of masking in humans.

The presently disclosed dynamic streaming technology can be applied to any coder that encodes source signals into multiple, independently decodable, consecutive frequency bands such as the NEM coder. The compressed data files are each organized into data units, which may also be called coding blocks or “NEM frames.” The NEM frames are independently decodable by the decoder in the player. Each NEM frame is further divided into smaller units, each referred to as a layer having a respective ID. A partially received frame containing data units from layers 1 to L (N being the maximum layer number, whereby L≦N) will still be decodable. Layers are thus indexed from 1 to N. Layers can be cumulatively assembled to construct a partially-received frame. The layer assigned the ID equal to 1 is referred to as the base layer. Layers with IDs higher than 1 are referred to as enhancement layers.

The underlying transmission network 64, 66 preferably provides packet-switching data service to multimedia applications. Maximum packet size is implicitly or explicitly specified and enforced by network interfaces. Transport control over the end-to-end path is enforced such that the server can only send a packet when the network allows it to do so. The network either explicitly defines the proper interval between packets that the application should adhere to, or allows the application to derive the proper interval. For example, such an interval is denoted as Δ(tᵢ), which represents the departure interval between packet i and i+1.

The end-to-end path 64, 66 is bi-directional, and preferably sustains delivery of at least the base layer of the content to a degree sufficient to avoid player receive-buffer underflow. As previously indicated, the base layer is regarded as layer 1. A player (i.e. the client) can send feedback to the server to indicate its buffer capacity status or reflective of information received in conjunction with streaming data, such as the time certain data was transmitted by the server and the time it was received by the player. The latter concept is discussed subsequently in the context of an innovative control protocol.

The period during which the server sends contiguous data (i.e. frames) from a particular layer is defined as the Active Duration (AD) of that layer. One layer may be transmitted by the server via multiple, serial data packets and may be defined by multiple, contiguous frames. If the data for an AD can reach the player in time, the data will generate a continuous playback period for that layer.

When considering layer dependency, the following preference assumption for streaming applications applies for networks having throughput constraints. All ADs of higher layers are embedded within ADs of lower layers.

Certain contextual assumptions are defined. The transport protocol employed for dynamic streaming must ensure that a dynamic streaming frame is either completely received or lost; no partially received dynamic streaming frame will be delivered by the underlying transport protocol.

In dynamic streaming, a framing mechanism is used to frame layers of scalable-coded bitstreams, such as an NEM bistream, into a defined structure that can delineate packet boundaries, delineate layer numbers, indicate frame and sub-frame ID, indicate frame and sub-frame length, and optionally indicate when the player should make a time stamp measurement. When the compressed audio is streamed through an unstable network, the scheduler of the streaming server, comprising bitstream scaling logic, has the capability of selecting the optimal number of layers for each coding frame for transmission to a receiving device. The intelligent selection of the layers to be transmitted is driven by the established connection conditions, such that the instantaneous bit rate can be adjusted in response to the fluctuation in connection throughput capacity. The likelihood of playback interruption at the receiver is thus greatly reduced or eliminated altogether.

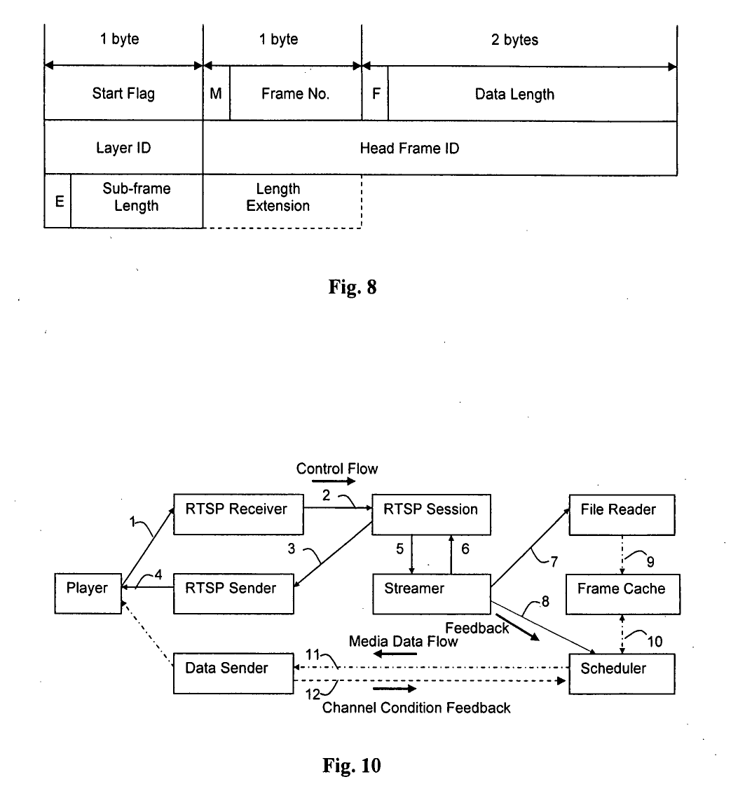

A set of consecutive sub-frames from one layer are encapsulated by the header illustrated in FIG. 8. All of the header information is sent in network byte order.

“Start Flag” signals to the player-side parser the start of a content data packet.

The “M” bit is set to “1” if a scalable codec is used and to “0” otherwise.

The “Frame No.” field represents the total number of sub-frames included under the respective header. They are generated by dividing an original frame into smaller data blocks, each such data block referred to as a sub-frame. Each sub-frame within a frame is represented by a sub-frame index. All sub-frames having a common index value form a layer.

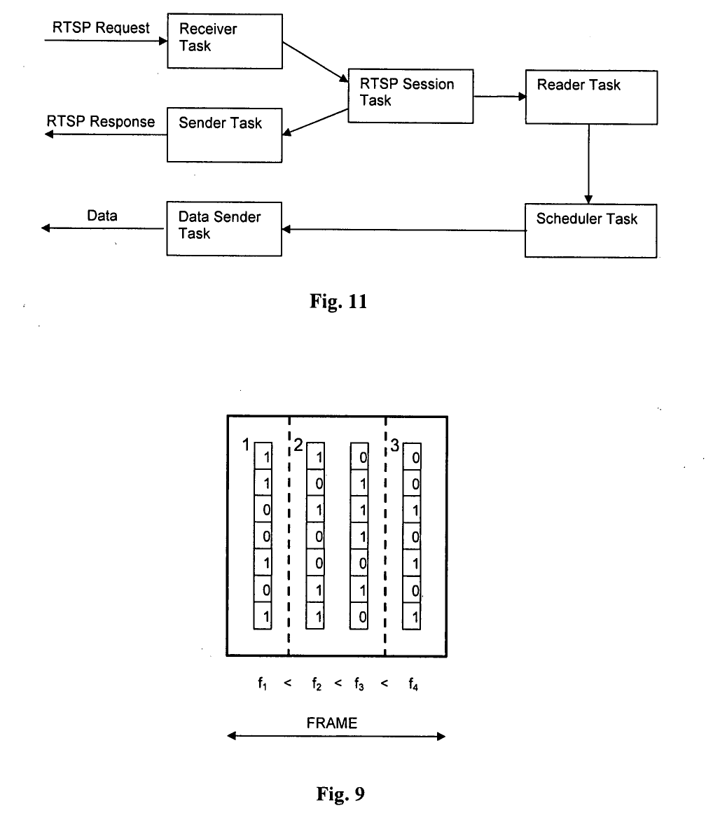

Sub-frames are necessary for implementing rate-adaptation according to the presently disclosed technique. Specifically, should transmission channel degradation dictate the need for restricting the data flow, a scalable coding method enables the server to adapt the content bit rate to the degradation. The source signal is encoded in a subband by subband fashion, as described above, whereby successive subbands are grouped into a common frequency layer. As shown in FIG. 9, an illustrative frame has been formed by three frequency-specific layers. Prior to transmission, if transmission channel conditions dictate, the highest frequency layers in each frame are simply omitted to appropriately decrease content bit rate and to achieve bandwidth scalability.

“Layer ID” indicates to the player which layer the constituent sub-frames belong to.

“Head Frame ID” identifies to the player the first frame ID of a set of consecutive frames.

“Sub-frame Length” defines the length in bytes of the sub-frames in the respective packet. The payload data contains as many sub-frames as indicated by the “Frame No.” field in the header. The “Sub-frame Length” field represents the beginning of the payload of the respective packet. If the “E” bit is set, the player interprets the “Sub-frame Length” field as the high byte of a compound sub-frame length and the “Length Extension” field as the low byte of the compound sub-frame length.

The information exchanged between the server and the player can be categorized into two categories of flows—data flow and control flow. All of the encoded frames sent from the server to the player constitute the data flow, while the control messages exchanged between the server and the player constitute the control flow. Data flow is unidirectional—from the server to the player. Control flow is bi-directional—the player sends status messages back to the Server in response to data and control messages sent by the server to the player.

FIG. 10 provides a block diagram of the functional blocks preferred for implementing dynamic streaming according to the presently disclosed invention, along with the data flows among those blocks. Eight functional blocks (ignoring for the time-being the player) and twelve interfaces, or data exchange paths, are illustrated. A variety of well-known computing platforms can be adapted for use in supporting these functions. The blocks and paths are addressed in the following description.

The RTSP Receiver is responsible for receiving and parsing RTSP requests from the player.

The RTSP Session block is responsible for handling standard RTSP requests pertaining to an RTSP streaming session. The requests may include a command selected from among: DESCRIBE; SETUP; PLAY; PAUSE; TEARDOWN; PING; SET_PARAMETER; and GET_PARAMETER. RTSP Session is also responsible for maintaining status parameters associated with each session. The RTSP Session functional block exchanges with the Streamer functional block to execute the streaming control actions requested through the received RTSP requests. Streamer, discussed subsequently, provides APIs for RTSP Session to execute the requested commands.

The RTSP Sender sends RTSP responses, created by the RTSP Session via the Streamer socket API, to the player.

The File Reader has two primary functions. First, it must open, load, and create frame and sub-frame indexing information necessary for locating each individual data unit within a source file. In the case of MPEG-4 encoded data files, an MPEG-4 utility module is utilized by the File Reader for these functions. Second, the File Reader must provide an API for enabling frame or sub-frame units of data to be read, for enabling a Session Description Protocol (SDP) segment to be obtained, and to facilitate file seek operations.

The Frame Cache functional block is a temporary work place for packet assembly. This function is guided by adaptation algorithms implemented by the Scheduler. The required functions of the Frame Cache include enabling centralized cache entry management including cache entry recycling, providing free cache buffer space for the File Reader, accommodating frame indexing, allowing random access to individual frames and sub-frames, enabling relatively low cache operation overhead, and providing APIs to the Scheduler for cache frame access.

The Scheduler is the intelligent component that implements novel algorithms to carry out packet generation and delivery. Required functions include the generation of packets according to a prescribed algorithm, the processing of feedback received from the player, and maintaining a parameter that controls the temporal interval between instances of packet departure. The latter parameter is adaptively adjusted by the Data Sender.

The Data Sender is primarily responsible for writing packets to the TCP socket and for performing throughput estimation. The latter enables the Data Sender to adaptively control the time interval by which the Scheduler is invoked for new packet generation.

Twelve data flows, also referred to as interfaces, are illustrated in FIG. 10. Each is briefly characterized in the following.

1—The RTSP Receiver only receives standard RTSP requests, thus minimizing system complexity.

2—The RTSP Session functional block provides an API for the RTSP Receiver to submit RTSP requests received from the player.

3—The RTSP Sender provides an API for the RTSP Session to submit RTSP response messages it has created back to the player. 4—Responses sent by the RTSP Sender must conform to the RTSP standard format.

5—The Streamer provides an API to the RTSP Session for processing RTSP requests issued by the player. The request types to be processed by the Streamer include: DESCRIBE; SETUP; PLAY; PAUSE; TEARDOWN; and SET_PARAMETER.

6—The RTSP Session provides an API for the Streamer to signal session-related events, which may include: reach the end of a media track; or a PAUSE point set by a PAUSE command has been reached.

7—The File Reader provides an API to the Streamer to enable the following control: start or stop the File Reader; and adjust the speed by which the File Reader reads frames from MPEG-4 formatted files.

8—The Scheduler provides an API to the Streamer in order to process feedback received via a SET_PARAMETER request. The types of feedback to be processed include: turn ON/OFF dynamic streaming mode; an F-bit count and the corresponding time of arrival at the player; the maximum adaptation range for the file encoding algorithm; the buffered frame numbers when the player starts to decode; and the timestamp at which the player starts to decode.

9—The Frame Cache provides an API for the File Reader to store encoded frames.

10—The Frame Cache provides an API to the Scheduler to selectively fetch frames or sub-frames for packet payload construction and to allow the Scheduler to flash frames from the cache that are deemed obsolete by a payload allocation algorithm.

11—The Data Sender provides an API for the Scheduler to submit packets to be sent out to the player.

12—The Scheduler provides an API for the Data Sender to adjust the parameter used to control the inter-departure time for packets.

The functional blocks depicted in FIG. 10 can be executed by six parallel tasks. The invoking relationship among the tasks is as depicted in FIG. 11.

These and other examples of the invention illustrated above are intended by way of example and the actual scope of the invention is to be limited solely by the scope and spirit of the following claims.

1. (canceled)

2. A method of dynamically adjusting the resolution of a coded data file during streaming, comprising:
accessing, by a server, the coded data file comprised of temporally sequential frames, each frame comprised of plural layers, each layer comprised of data for a respective frequency band;
analyzing, at the server, an indication of the capability of a client device in communication with the server to process the coded data file as streamed by the server; and
selecting at least one layer to be retained per frame according to the analysis of the indication.

3. The method of claim 2, wherein the at least one layer comprises at least the layer comprised of data for the lowest frequency band for the respective frame.

4. The method of claim 2, wherein the at least one layer comprises the layer comprised of data for the lowest frequency band for the respective frame and one or more layers comprised of data for consecutively higher frequency bands for the respective frame.

5. The method of claim 2, wherein the coded data file is coded using a neural encoding model.

6. The method of claim 2, wherein the indication is reflective of client device receive buffer status.

7. The method of claim 6, wherein the indication is reflective of the current playback position relative to the remaining buffered data in a client device playback buffer.

8. The method of claim 2, wherein the indication is reflective of a time at which a specific frame was received by the client device.

9. The method of claim 8, wherein the indication is further reflective of a time at which the specific frame was transmitted by the server to the client device.

10. The method of claim 2, further comprising the step of transmitting sequential frames of the coded data file from the server to the client device after performing the step of selecting each frame.

11. The method of claim 10, wherein the step of transmitting comprises transmitting sequential frames via a packet-switched network.

12. The method of claim 2, wherein the steps of analyzing and selecting are performed for each frame.

13. The method of claim 2, wherein the layers of the coded data file frames are independently decodable.

14. The method of claim 2, wherein the layers of the coded data file frames are each associated with a unique frequency range.

15. The method of claim 2, wherein the layers of the coded data file frames are each approximately 100 to 400 Hertz wide.

16. The method of claim 2, wherein sequential ones of the coded data file frames overlap in time.

17. The method of claim 2, wherein the coded data file frames are each approximately 10 to 500 milliseconds in length.

18. The method of claim 2, wherein each coded data file frame is comprised of plural sub-frames.

19. The method of claim 18, wherein each of the plural sub-frames is of substantially the same window length.

20. A server capable of dynamically adjusting the resolution of a coded data file during a streaming session, comprising:
a file reader for accessing the coded data file comprised of temporally sequential frames, each frame comprised of plural layers, each layer comprised of data for a respective frequency band; and
a scheduler for analyzing an indication of the status of a client device in communication with the server to process the coded data file to be streamed by the server and for selecting at least one layer to be retained within each frame according to the analysis of the status indication.

21. The server of claim 20, further comprising a receiver and a sender for communicating streaming session control information between the server and the client device.

22. The server of claim 21, wherein the receiver and sender are configured to utilize RTSP as the session control protocol.

23. The server of claim 20, further comprising a streamer module for communicating session control signals to the scheduler.

24. The server of claim 20, further comprising a sender for receiving frames from the scheduler, each having at least one layer to be retained as selected by the scheduler, for streaming the frames to the client device, for receiving the indication, and for providing the indication to the scheduler.

25. The server of claim 20, wherein the sender is configured for streaming the frames to the client device via a packet-switched network.

26. The server of claim 20, wherein the scheduler is further for selecting at least the layer comprised of data for the lowest frequency band to be retained within the respective frame.

27. The server of claim 20, wherein the scheduler is further for selecting at least the layer comprised of data for the lowest frequency band and one or more layers comprised of data for consecutively higher frequency bands to be retained within the respective frame.

28. The server of claim 20, wherein the coded data file is coded using a neural encoding model.

29. The server of claim 20, wherein the indication is reflective of the status of data buffered in advance of the current payback position in the client device receive buffer.

30. The server of claim 20, wherein the indication is reflective of a time at which a specific frame was received by the client device.

31. The server of claim 30, wherein the indication is further reflective of a time at which the specific frame was transmitted by the server to the client device.

32. The server of claim 20, wherein the scheduler is configured for selecting at least one layer to be retained for each of successive frames.

33. The server of claim 20, wherein the layers of the coded data file frames are independently decodable.

34. The server of claim 20, wherein the layers of the coded data file frames are each associated with a unique frequency range.

35. The server of claim 20, wherein the layers of the coded data file frames are each approximately 100 to 400 Hertz wide.

36. The server of claim 20, wherein sequential ones of the coded data file frames overlap in time.

37. The server of claim 20, wherein the coded data file frames are each approximately 10 to 500 milliseconds in length.

38. The server of claim 20, wherein each coded data file frame is comprised of plural sub-frames.

39. The server of claim 38, wherein each of the plural sub-frames is of substantially the same window length.
